(19) United States
(12) Patent Application Publication
(10) Pub. No.: US 2009/0100335 A1
(43) Pub. Date: Apr. 16, 2009

(54) METHOD AND APPARATUS FOR IMPLEMENTING WILDCARD PATTERNS FOR A SPELLCHECKING OPERATION

(76) Inventors: John Michael Garrison, Austin, TX (US); Michael S. McKay, Round Rock, TX (US)

Correspondence Address: IBM CORP (YA);C/O YEE & ASSOCIATES PC, P.O. BOX 802333, DALLAS, TX, 75380, US

(21) Appl. No.: 11/870,289

(22) Filed: Oct. 10, 2007

(51) Int. Cl. G06F 15/00

(52) U.S. Cl. 715/257

(57) ABSTRACT

A computer implemented method, apparatus, and computer usable program product for implementing wildcard patterns for a spellchecking operation. The process parses a set of words of a document using a dictionary of wildcard patterns to identify a set of wildcard strings in response to receiving a request to perform a spellchecking operation on the document. Thereafter, the process generates a visual cue identifying a subset of words as potentially misspelled, wherein the subset of words comprises words from the set of words that are absent from the set of wildcard strings.

### BACKGROUND OF THE INVENTION

1. Field of the Invention

The present invention relates generally to an improved data processing system and in particular to a computer implemented method and apparatus for spellchecking. More particularly, the present invention is directed to a computer implemented method, apparatus, and computer usable program product for implementing wildcard patterns for a spellchecking operation.

2. Description of the Related Art

Spellchecking is a process of verifying the spelling of words used in a document. Words may include strings of alphanumeric text, and the document may be, for example, memos, email, presentations, reports, or any other similar type of text-based documentation. Spellchecking may be performed by a word processing application, email application, or software application used to create the text-based documentation.

Currently used methods for spellchecking a document involve comparing words of the document with words in one or more dictionaries. The dictionaries may be, for example, a standard word dictionary that is packaged with a word processing application or email application. Standard word dictionaries include commonly used words. In addition, the standard word dictionaries may include user-added words. Additionally, a standard word dictionary may be one or more supplemental, specialized dictionaries. A specialized dictionary is a database of words relating to a specific subject matter. For example, a specialized dictionary may contain words specific to the medical profession so that medical journals reciting complicated terms and acronyms are not marked as misspelled when they are in fact properly spelled.

In some instances, words used in documents may not be located in either a standard dictionary or a specialized dictionary. As a result, a spellchecking process may identify otherwise correctly spelled words as incorrectly spelled. For example, a company may implement a policy specifying that documents must be named according to a particular format. The format may specify that the document name is to include a three letter prefix specifying a location from which the document originated, followed by a four number sequence representing the year in which the document was created, followed by a unique four number identifier, and a suffix identifying a status of a document. Thus, the document filename may include the string NYC20070123DRAFT. Although this filename is technically correctly spelled, many spellchecking processes may identify this string of characters as improperly spelled.

Consequently, currently used methods for spellchecking documents may identify correctly spelled words as incorrectly spelled despite the fact that the accuracy of similarly spelled words has already been verified. Thus, authors of documents are required to verify the spelling of every word of a document not present in one or more dictionaries. This method is time consuming and inefficient. Therefore it would be advantageous to have a method and apparatus that overcomes these problems.

### SUMMARY OF THE INVENTION

The illustrative embodiments described herein provide a computer implemented method, apparatus, and computer usable program product for implementing wildcard patterns for a spellchecking operation. The process parses a set of words of a document using a dictionary of wildcard patterns to identify a set of wildcard strings in response to receiving a request to perform a spellchecking operation on the document. Thereafter, the process generates a visual cue identifying a subset of words as potentially misspelled, wherein the subset of words comprises words from the set of words that are absent from the set of wildcard strings.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a block diagram of a data processing system in which the illustrative embodiments may be implemented;

FIG. 3 is a block diagram of a computing device of a system in which the illustrative embodiments may be implemented; and

FIG. 4 is a flowchart illustrating a process for using wildcard patterns in a dictionary for spellchecking.

### DETAILED DESCRIPTION OF THE PREFERRED EMBODIMENT

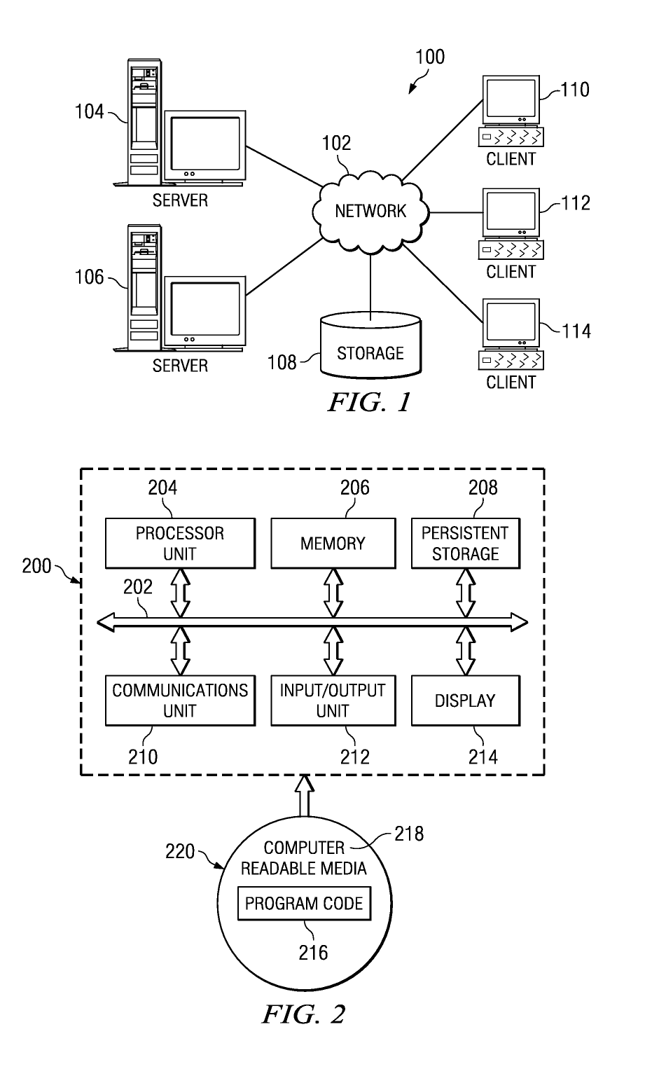

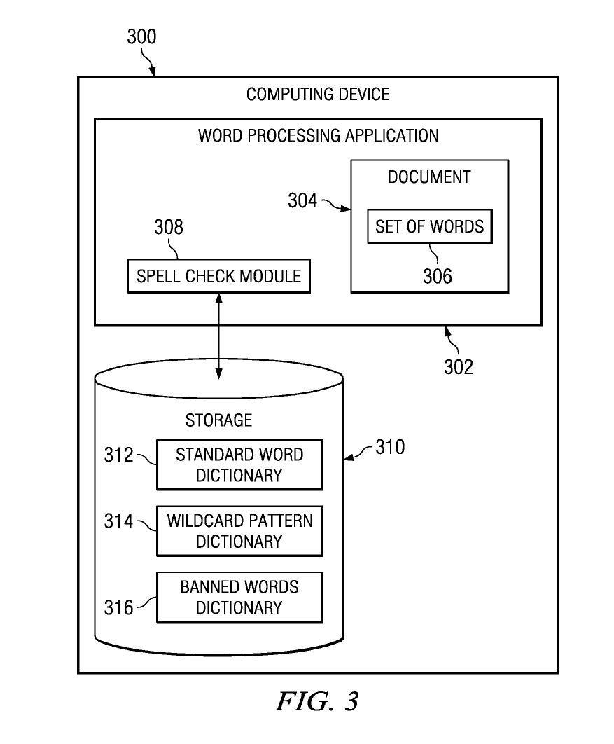

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing system in which illustrative embodiments may be implemented. Network data processing system 100 is a network of computing devices in which embodiments may be implemented. Network data processing system 100 contains network 102, which is the medium used to provide communications links between various devices and computers connected together within network data processing system 100. Network 102 may include connections, such as wire, wireless communication links, or fiber optic cables. The depicted example in FIG. 1 is not meant to imply architectural limitations. For example, data processing system 100 also may be a network of telephone subscribers and users.

In the depicted example, server 104 and server 106 connect to network 102 along with storage unit 108. In addition, clients 110, 112, and 114 are coupled to network 102. Clients 110, 112, and 114 are examples of devices that may be utilized for transmitting or receiving audio-based communication in a network, such as network 102. Clients 110, 112, and 114 may be, for example, a personal computer, a laptop, a tablet PC, a network computer, a hardwired telephone, a cellular phone, a voice over internet communication device, or any other communication device or computing device capable of transmitting data. In the depicted example, server 104 provides data, such as boot files, operating system images, and applications to clients 110, 112, and 114. Clients 110, 112, and 114 are coupled to server 104 in this example. Clients 110, 112, and 114 may be operated by users for generating and/or reviewing documents. The review of documents may include the performance of spellcheck operations, such as the spellcheck operations using wildcard patterns as disclosed herein.

Network data processing system 100 may include additional servers, clients, computing devices, and other devices for transmitting or receiving audio-based communication. The clients and servers of network data processing system 100 may be configured to host one or more software components that form a distributed software application. Alternatively, the clients and servers of network data processing system 100 may host one or more virtual machines for hosting one or more software components that form a distributed software application.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), a wide area network (WAN), a telephone network, or a satellite network. FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, memory 206 or a cache. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

The illustrative embodiments described herein provide a computer implemented method, apparatus, and computer usable program product for implementing wildcard patterns for a spellchecking operation. The process parses a set of words of the document using a dictionary of wildcard patterns to identify a set of wildcard strings in response to receiving a request to perform a spellchecking operation on a document. Thereafter, the process generates a visual cue identifying a subset of words as potentially misspelled, wherein the subset of words comprises words from the set of words that are absent from the set of wildcard strings.

In an illustrative embodiment, the set of words parsed by the process is the set of words identified as potentially misspelled upon conclusion of a first spellchecking operation performed using a dictionary of standard words. In addition, the process may perform a subsequent spellchecking operation using a dictionary of banned words. Thus, words identified as potentially misspelled upon completion of a spellchecking operation and which are not also identified as wildcard strings are identified to a user as potentially misspelled. Further, words of the document which are present in the dictionary of banned words are also identified to a user as potentially misspelled.

As used herein, a set may mean one or more. Thus, a set of wildcard strings is one or more wildcard strings.

FIG. 3 is a block diagram of a computing device of a system in which illustrative embodiments may be implemented. Computing device 300 is a computing device such as client 110 and server 104 in FIG. 1 and may be implemented using data processing system 200 in FIG. 2.

In this illustrative example, computing device 300 hosts word processing application 302. Word processing application 302 is a software application operable by a user for generating and/or reviewing documents. Word processing application 302 may be, for example, without limitation, Microsoft Word®, Microsoft Outlook®, Eudora®, Wordperfect®, PowerPoint®, or any other similar type of word processing application usable to create documents.

Microsoft Word, Outlook, and PowerPoint are registered trademarks of Microsoft Corporation. Eudora is a registered trademark of the Board of Trustees of the University of Illinois, licensed to Qualcomm Incorporated. Wordperfect is a registered trademark of Corel Corporation Limited.

Word processing application 302 is operable by a user (not shown) to perform operations on document 304, such as, for example, draft, review, or revise. Document 304 is a file having, among other things, text-based information. Document 304 may be, for example, a PowerPoint presentation, a word processing document, an email message, a computer file, a scanned image of a handwritten document, a text message, an instant message, or any other similar type of document including words or alphanumeric strings of text.

The text-based information of document 304 is represented by set of words 306. Set of words 306 is one or more words, alphanumeric strings of text, acronyms, numbers, abbreviations, or any combination thereof, which forms the substance of document 304.

Word processing application 302 also includes spellcheck module 308. Spellcheck module 308 is a software component operable by word processing application 302 configured to check the spelling of set of words 306 of document 304. Spellcheck module 308 may be a component of word processing application 302 or a separate component of word processing application 302 at the disposal of word processing application 302.

Spellcheck module 308 verifies the spelling of document 304 by comparing the words of set of words 306 with one or more dictionaries. As used herein, a dictionary is a collection of words. The dictionary may be, for example, a database, a list, or a table of words. In this illustrative embodiment, the dictionaries utilized by spellcheck module 308 for checking the spelling of set of words 306 are stored in storage 310. Storage 310 is a storage device for storing data. Storage 310 is a storage device such as storage 108 in FIG. 1.

In this illustrative example in FIG. 3, spellcheck module 308 utilizes standard word dictionary 312, wildcard pattern dictionary 314, and banned words dictionary 316 for checking the spelling of set of words 306. Standard word dictionary 312 is a dictionary of commonly used terms, which is often packaged with word processing application 302. Standard word dictionary 312 contains commonly used words. In addition, standard word dictionary 312 also includes words added by users of word processing application 302.

Wildcard pattern dictionary 314 is a dictionary of wildcard patterns. A dictionary of wildcard patterns is a collection of words or rule sets defining wildcard strings. A wildcard pattern is an alphanumeric string of text having one or more wildcard characters or wildcard symbols replacing one or more characters of the string. A wildcard pattern may be, for example, AUS8*. The corresponding wildcard symbol, in this example, is the asterisk. The asterisk replaces any combination of characters that may follow the AUS8 prefix. Valid wildcard patterns are stored in wildcard pattern dictionary 314. Thus, if wildcard pattern dictionary 314 includes an entry for AUS8*, then spellcheck module 308 will conclude that wildcard strings AUS820043766, AUS820032341, and AUS820027689 are correctly spelled. A wildcard string is a word or alphanumeric string of text that comports with a wildcard pattern. Thus, if AUS8* is a wildcard pattern, then AUS820043766 is a wildcard string.

Wildcard patterns may specify any location in which a wildcard symbol may be located in a wildcard string. For example, *.java is a wildcard pattern that enables spellcheck module 308 to identify any wildcard string with the suffix java to be considered correctly spelled. Further, multiple wildcard characters may be used, as in the following example: *\program files\*.

Any character, symbol, or combination of characters or symbols may be used to substitute characters of an alphanumeric string to define a wildcard string. For example, the asterisk may be replaced with a question mark. In addition, a wildcard string may include a combination of characters or symbols, such as, for example, AUS8 ([A-Z, 0-9]{4-8}). In this example, the prefix AUS8 may be followed by any combination of four to eight letters and/or numbers.

Banned words dictionary 316 is a dictionary of words that has been identified as undesirable. Words that may be included in banned words dictionary 316 may include, for example, vulgar or obscene words or colloquial phrases deemed inappropriate for use in particular types of documents. In addition, banned word dictionary 316 may include any other words or phrases added by a user. For example, if a company, such as the fictional ACME Corporation is bought out by MegaCorp, another fictional corporation, then MegaCorp may create an entry in banned word dictionary 316 specifying that the phrase “ACME Corporation” as potentially misspelled.

In one example, wildcard patterns and banned words may be added to their respective dictionaries by users of word processing application 302 during a spellcheck operation. In one illustrative example, spellcheck module 308 may identify words as possibly misspelled by generating a visual cue identifying a subset of the words of set of words 306 as potentially misspelled. The subset of words of set of words 306 is one or more words. The visual cue may be any cue, such as, for example, underlining, highlighting, bolding, italics, or any other form of cue or indicator. If the user right clicks on the underlined word or phrase, then spellcheck module 308 may present the user with suggested spellings of the word or phrase, may allow the user to ignore the possibly misspelled word, or may allow the user to add the word or phrase to either standard word dictionary 312, wildcard pattern dictionary 314, or banned word dictionary 316.

In the illustrative example shown in FIG. 3, spellcheck module 308 utilizes standard word dictionary 312, wildcard pattern dictionary 314, and banned word dictionary 316 for checking the spelling of set of words 306, in alternate embodiments, spellcheck module 308 may reference a single dictionary storing standard words, wildcard patterns, and banned words.

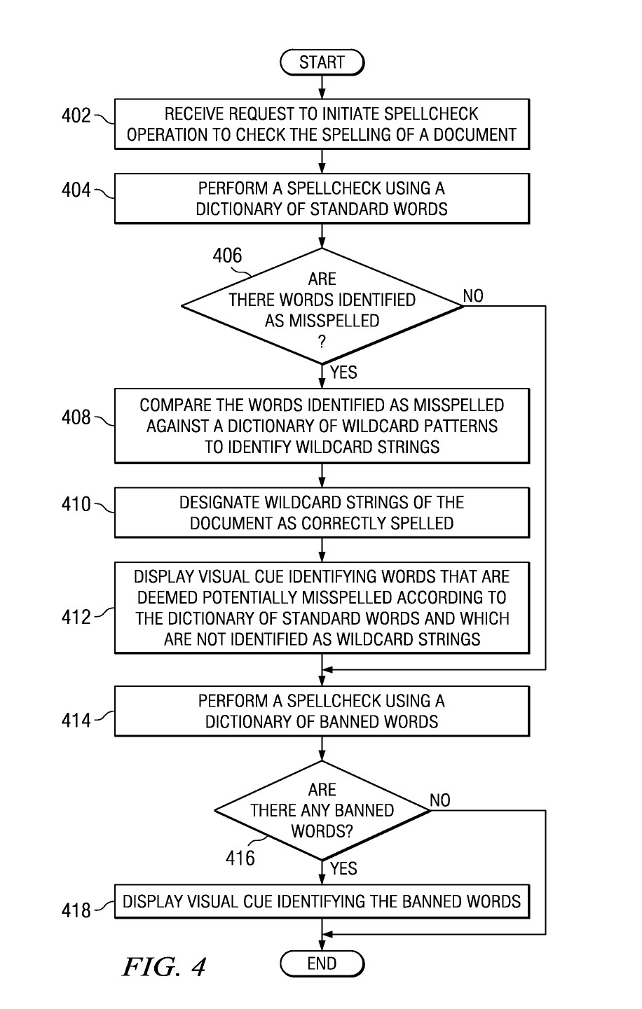

FIG. 4 is a flowchart of an exemplary process for utilizing wildcard patterns for spellchecking documents. The process may be performed by a software component, such as spellcheck module 308 in FIG. 3.

The process begins by receiving a request to initiate a spellcheck operation to check the spelling of a set of words of a document (step 402). The process then performs a spellcheck using a dictionary of standard words (step 404). The process then makes the determination as to whether there are words identified as misspelled (step 406).

If the process makes the determination that there are words identified as misspelled, the process compares the words identified as misspelled against a dictionary of wildcard patterns to identify wildcard strings (step 408). The dictionary of wildcard patterns may be the same dictionary as the dictionary of standard words. Alternatively, the dictionary of wildcard patterns may be a separate dictionary of words.

Thereafter, the process designates wildcard strings of the document as correctly spelled (step 410). In one example, the process may identify words as correctly spelled by removing any visual indicator designating a word as potentially misspelled as a result of performing a spellchecking operation using the dictionary of standard words. The process then displays a visual cue identifying words that are deemed potentially misspelled according to the dictionary of standard words, and which are also not identified as wildcard strings (step 412).

The process then performs a spellcheck using a dictionary of banned words (step 414). The process then makes the determination as to whether there are any words of the document that are present in the dictionary of banned words (step 416). The process may make this determination by comparing the words of a document with words included within a dictionary of banned words. If the process makes the determination that the document does not contain words present in the dictionary of banned words, then the process terminates thereafter. However, if the process makes the determination that there are words of the document present in a dictionary of banned words, then the process displays a visual cue identifying the words of the document that are also present in the dictionary of banned words (step 418) and the process terminates thereafter.

Returning now to step 406, if the process does not identify any potentially misspelled words, then the process continues to step 414.

As with any traditional spellchecking process, users who have initiated a spellchecking process may choose to change the spelling of a word identified as misspelled. The user may select from a list of suggested words or manually enter the correct spelling of the misspelled word. In addition, the user may ignore any words identified as misspelled, or add the potentially misspelled word to the dictionary of standard words. The user may also have the option to create a wildcard pattern so that similarly spelled words may be deemed correctly spelled in subsequent portions of the document, or in subsequently generated documents.

Although in FIG. 4, words identified as misspelled with reference to a dictionary of standard words are then parsed with reference to entries of a dictionary of wildcard strings, in an alternate embodiment, a spellcheck module may parse a set of words of a document against a dictionary of wildcard strings before or concurrently with a process for checking the spelling of words against a dictionary of standard terms.

The flowcharts and block diagrams in the different depicted embodiments illustrate the architecture, functionality, and operation of some possible implementations of methods, apparatus, and computer usable program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the illustrative embodiments described herein provide a computer implemented method, apparatus, and computer usable program product for implementing wildcard patterns for a spellchecking operation. The process parses a set of words of a document using a dictionary of wildcard patterns to identify a set of wildcard strings in response to receiving a request to perform a spellchecking operation on the document. Thereafter, the process generates a visual cue identifying a subset of words as potentially misspelled, wherein the subset of words comprises words from the set of words that are absent from the set of wildcard strings.

The computer implemented method and apparatus disclosed herein provide additional functionality for performing a spellchecking operation in a word processing application. In particular, a set of words of a document may be spellchecked against a dictionary of wildcard patterns to identify wildcard strings as correctly spelled. In this manner, users are not required to continually add similarly spelled strings of text to dictionaries, especially if the strings are infrequently used. A wildcard pattern may be created so that a single entry in a dictionary of wildcard patterns may identify as correctly spelled every possible wildcard string complying with the wildcard pattern.

Consequently, with some or all of the different embodiments, a user is not required to spend as much time spellchecking documents. Further, the number of entries of dictionaries is not unnecessarily augmented. As a result, a processor may actually complete a spellchecking operation quicker than if the processor had to reference a dictionary having substantially more entries.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for implementing wildcard patterns in a spellchecking operation, the computer implemented method comprising:
responsive to receiving a request to perform a spellchecking operation on a document, parsing a set of words of the document using a dictionary of wildcard patterns to identify a set of wildcard strings; and
generating a visual cue identifying a subset of words as potentially misspelled, wherein the subset of words comprises words from the set of words that are absent from the set of wildcard strings.

2. The computer implemented method of claim 1, wherein the set of words are formed from words designated as potentially misspelled according to a dictionary of standard words.

3. The computer implemented method of claim 1, further comprising:
identifying a set of banned words as potentially misspelled, wherein the set of banned words are stored in a dictionary of banned words.

4. The computer implemented method of claim 1, wherein the visual cue is underlining.

5. A computer program product comprising:
a computer usable medium including computer usable program code for implementing wildcard patterns in a spellchecking operation, the computer program product comprising:
computer usable program code for parsing a set of words of a document using a dictionary of wildcard patterns to identify a set of wildcard strings in response to receiving a request to perform a spellchecking operation on the document; and
computer usable program code for generating a visual cue identifying a subset of words as potentially misspelled, wherein the subset of words comprises words from the set of words that are absent from the set of wildcard strings.

6. The computer program product of claim 5, wherein the set of words are formed from words designated as potentially misspelled according to a dictionary of standard words.

7. The computer program product of claim 5, further comprising:
computer usable program code for identifying a set of banned words as potentially misspelled, wherein the set of banned words are stored in a dictionary of banned words.

8. The computer program product of claim 5, wherein the visual cue is underlining.

9. An apparatus comprising:
a bus system;
a processing unit connected to the bus system;
a storage device connected to the bus system, wherein the storage device includes program code executed by the processing unit for parsing a set of words of a document using a dictionary of wildcard patterns to identify a set of wildcard strings in response to receiving a request to perform a spellchecking operation on the document; and generating a visual cue identifying a subset of words as potentially misspelled, wherein the subset of words comprises words from the set of words that are absent from the set of wildcard strings.

10. The apparatus of claim 9, wherein the set of words are formed from words designated as potentially misspelled according to a dictionary of standard words.

11. The apparatus of claim 9, wherein the program code further comprises:
computer code for identifying a set of banned words as potentially misspelled, wherein the set of banned words are stored in a dictionary of banned words.

12. The apparatus of claim 9, wherein the visual cue is underlining.
